(19) United States
(12) Patent Application Publication
(10) Pub. No.: US 2013/0118766 A1
(43) Pub. Date: May 16, 2013

(54) AIR HAMMER TOOL, AND METHOD OF ADJUSTING IMPACT FORCE OF THE AIR HAMMER TOOL

(71) Applicant: Apuren Co., Ltd., Aichi (JP)

(72) Inventor: Yukio WATANABE, Aichi (JP)

(73) Assignee: APUREN CO., LTD., Aichi (JP)

(21) Appl. No.: 13/672,238

(22) Filed: Nov. 8, 2012

(30) Foreign Application Priority Data
Nov. 10, 2011 (JP) 2011-246970

(51) Int. Cl. B25D 17/24; B25D 9/04

(52) U.S. Cl. CPC B25D 17/24; B25D 9/04
USPC 173/1; 173/211

(57) ABSTRACT

[Problem to be Solved] To provide an air hammer tool which largely reduces transmission of vibration to a worker, has a simple and light-weight structure, can he manufactured at a low cost, and can be easily maintained.

[Solution] An air hammer tool. 1A has a single coil spring 9 (elastic body) externally fitted on the outer periphery of a cylinder portion 11 of a sliding body 8, the coil spring 9 as a compression spring is interposed between a spring stop member 16 which is fixed to the front end portion of a main body portion 3b and a front end face 10a of the sliding body 8, when a trigger 4a is operated, the sliding body 8 obtains a state where it is pushed forward by compressed air to elastically contract the coil spring 9, and the sliding body 8 obtains a rearward urged state

### TECHNICAL FIELD

The present invention relates to an air hammer tool which is configured for, for example, a rock drill, a concrete breaker, a chipping machine, a nailer, a riveting machine, a pile driver, a land leveler, a compactor, a rammer, a tamper, a road roller, an asphalt or concrete ground leveling machine, a so-called jet chisel and the like.

### BACKGROUND ART

Conventionally, the above air hammer tool has been proposed in a variety of types (see Patent. Documents 1 to 4). Further, in order to prevent a shock generated by reciprocation of a piston mounted in the air hammer tool from being transmitted to a worker there has already been disclosed a structure provided with a vibration proof device (see Patent Document 5). For example, the structure disclosed in Patent Document 5 has a buffer mechanism at a rear end of an air hammer main body and said buffer mechanism is configured with a buffer chamber which is filled with a buffer liquid, a buffer cylinder in which a buffer sliding body is inserted, and a communication hole which is formed in the buffer cylinder to communicate between the buffer chamber and the inside of the buffer cylinder.

### PRIOR PUBLICATION

### Patent Documents

[Patent Document 1]

JP-B-4340081

[Patent Document 2]

JP-B-3825802

[Patent Document 3]

JP-B-2746712

[Patent Document 4]

JP-A-Hei 8-197158

[Patent Document 5]

JP-A-Hei 9-11156

### DISCLOSURE OF THE INVENTION

### Problem to Be Solved by the Invention

However, since the structures of the above Patent Documents 1 to 4 are configured such that a tip tool such as a chisel, which has obtained kinetic energy by the impact of the hammer, vibrates strongly to the tool main body, the tool main body also vibrates strongly due to a counteraction to the vibration. Therefore, in order to prevent the air hammer tool from jumping away or to prevent the tip tool from displacing from the object to be impacted such as an object. to be crushed, or in order to transmit effectively the force by the vibration of the tip tool to the object to be impacted, the working worker must keep holding the tool main body against the strong vibration. Accordingly, she transmission of the strong vibration to the worker causes a problem that its long use had a high probability of causing a serious disorder such as vibration white finger disease to the body of the worker. Further, noise generated during the work by the vibration of the tip tool, the impact between the tip tool and the hammer, or the like may cause a hearing disorder to the worker and people around the work site.

The structure of the above Patent Document 5 has a possibility that the above problems can be solved. However, to fill the tool main body with a buffer liquid in an amount enough to obtain a sufficient buffer effect, the buffer chamber becomes large, so the air hammer becomes large as the whole, and its weight increases. As a result, there is a problem that it becomes very difficult for the worker to handle the tool. Further, since the buffer liquid must be filled into the air hammer main body without leaking, there are also problems that the inside structure becomes very precise and complex, and the manufacturing cost largely increases. in addition, since the number of parts of the air hammer tool also increases, this also causes problems that thorough cleaning becomes quite troublesome and maintenance cannot easily be carried out

Therefore, because of the above reasons, the structure disclosed in the Patent Document 5 provides little in practical utility and it has not been available in the market at present.

Therefore, the present invention aims to provide an air hammer tool which reduces remarkably vibration and noise to be transmitted to the worker, has a simple and light-weight structure, can be manufactured at a low cost and can be maintained readily, and a method of adjusting an impact force of the air hammer tool.

### Means for Solving the Problem

The present invention relates to an air hammer tool, including a over body and a tip tool which is extended forward from the cover body; and

an impact force obtained by a gas, which is pressured. and injected into said cover body, being applied to an object to be impacted through said tip tool,

wherein said cover body has an inner space portion which is formed along the longitudinal direction, a gas pressure-injection portion which is formed in the peripheral wall of the cover body to a gas pressured and injected, forward into the inner space portion, the inner space portion has therein a longitudinally slidable sliding body and an elastic body which is interposed between the outer peripheral surface of the sliding body and the inner peripheral surface of the cover body,

said sliding body has a sliding body main body and a cylinder portion which has a cylindrical shape and is disposed at a front end portion of the sliding body main body to protrude forward from said cover body,

a gas introduction portion for guiding the gas pressured and injected, into said cover body into the cylinder portion and a gas introduction portion is formed in a peripheral wall of the cylinder portion, a hammer is longitudinally slidably loaded in the cylinder portion, a rear end portion of said tip tool is fixed to a front-end opening portion of the cylinder portion to be impactable with said hammer,

when the gas is pressured and injected into said over body through said gas pressure-injection portion, said sliding body is moved forward in the cover body by the pressure of the gas while elastically deforming the elastic body, and the hammer is longitudinally reciprocated within the cylinder portion by the gas introduced into said cylinder portion through said gas introduction portion, and said hammer repeatedly impact against the rear end portion of said tip tool, thereby providing said impact force.

As described above, the air hammer tool of the present invention has a first feature such that the cover body and the sliding body in which the hammer for impacting against the tip tool is inserted are provided as separate bodies, and the elastic body is interposed between the cover body and the sliding body. In the above structure, since the shock generated by the impact between the hammer in the sliding body and the tip tool, and the inertia of the hammer performing the reciprocating motion are properly absorbed. by the elastic body, large vibration is hindered from being transmitted to the worker who is holding the cover body.

And, in addition to the above first feature, the air hammer tool of the present invention has a second feature such that the cylinder portion and the tip tool are fixed to make the tip tool unmovable with respect to the cylinder portion. In the above structure, when the impact force is applied to the object to be impacted to perform, the work, the tip tool is brought into contact with the object to be impacted and the air hammer tool is operated. Then, when the hammer in the cylinder portion is impacted against the tip tool, the tip tool functions as a so-called “chisel”, and the impact force obtained by the inertia of the hammer is applied to the object to be impacted through the tip tool. Therefore, in comparison with a conventional structure where the impact force is applied to the object to be impacted by the vibration of the tip tool itself, the air hammer tool does not vibrate strongly, and no noise is generated by the vibration of the tip tool itself. Therefore, in cooperation with the advantage of the above first feature, vibration transmitted to the worker and noise are lowered remarkably, and the air hammer tool in consideration of the health of the worker and the like can be provided.

In addition, the above air hammer tool of the present invention has a third feature such that the tip tool is in a forward protruded. position with the forward movement of the sliding body by the pressure of the injected. gas during the work, and when the gas injection is stopped in order to pause the work, the sliding body is returned to the original position by the restoring force of the above elastic body and the tip tool comes into a retreated position. That is, to pause the work, it is normally necessary that the worker stop injection of the gas and operate to separate the air hammer tool itself from the object to be impacted to separate the tip tool from the object to be impacted. However, according to the present invention, the tip tool itself retreats rearward to separate from the object to be impacted without intentionally operating to separate the air hammer tool itself from the object to be impacted. Therefore, for example, when the air hammer tool of the present invention is used to process plural workpieces (objects being impacted) sequentially, it becomes possible to replace the workpieces sequentially at each time when the tip tool separates from the workpiece without performing operation to separate the air hammer tool itself from the workpiece at each time when the operation is paused.

In the above structure, it is suggested that the elastic body be a coil spring, and the coil spring be interposed in a longitudinal y oriented state between a front end face of the sliding body and an inner peripheral surface of the cover body, and when the gas is pressured and injected into the cover body through the gas pressure-injection portion to move the sliding body forward, the coil spring elastically contracts to urge the sliding body rearward.

When the sliding body is moved forward, the coil spring which is elastically contracted to urge the sliding body rearwardly has both a function to absorb the shock generated when the hammer in the sliding body and the tip tool, are impacted against each other and the inertia of the hammer which performs the reciprocating motion and a function to return the sliding body to the original position when the pressured gas Injection is stopped to pause the operation. Further, the air hammer tool in the above structure has a extremely simple inside structure because it uses an elastic body formed of a solid material not using a buffer liquid and does not require addition of a special large mechanism other than the coil spring. Therefore, an increase in weight as a whole is lowered, and the whole tool becomes compact. This prevents deterioration of handling characteristics and excellently facilitates maintenability.

Here, in the above structure having only the coil spring which is interposed between the front end face of the sliding body and the inner peripheral surface of the cover body, the vibration transmitted to the worker is remarkably reduced by the above described function of the coil spring of absorbing the shock and the like. However, since the sliding body is kept in a state where it is always urged rearward by the reaction force of the coil spring at the time of use, there is a possibility that the pushing force of the tip tool to the object to be impacted decreases, the whole impact force becomes weak, or if the supply of the injection pressured as to push out the sliding body forward becomes instable, the sliding body jumps in the cover body and a stable impact force cannot be obtained. Therefore, the following structure is proposed for a further improvement.

That is, the coil spring as the elastic body is interposed in a longitudinally oriented and elastically contracted state between the rear end face of the sliding body and the inner peripheral surface of the over body, and the coil spring is configured to urge the sliding body forward when the gas is pressure injected into the cover body through the gas pressure-injection portion to move forward the sliding body.

In the above structure, the coil spring, which is elastically contracted to urge the sliding body forward when the sliding body moves forward, holds the sliding body appropriately to push appropriately the tip tool against the object to be impacted and to enable prevention of jumping of the sliding body. Thus, stable impact force can be obtained.

In addition, the present invention relates to a method of adjusting an impact force of the above-described air hammer tool, in which the coil spring interposed between the front end face of the sliding body and the inner peripheral surface of the cover body is provided as a first coil spring, the coil spring interposed between the rear end face of the sliding body and the inner peripheral surface of the cover body is provided as a second coil spring, and urging force of the second coil spring against the sliding body is changed to adjust the impact force.

For example, when the urging force of the second coil, spring against the sliding body is increased, the impact force increases, and when the urging force is reduced, the impact force reduces. When the above structure is adopted, it becomes possible to easily and finely adjust the impact force of the air hammer tool while large vibration is prevented from being transmitted to the worker.

Further, the following structure may also be adopted. That is, it is a structure where an air control body to which a gas is supplied from the outside is disposed in the rear of the cover body, the gas supplied from the outside is guided to the gas pressure-injection portion, which is disposed in the cover body, by operation of the switch of the air control switch portion disposed on the air control body, and a cylindrical grip body is externally fitted in the longitudinal direction on the outer periphery of the cover body and/or the outer periphery of the air control body via an elastic member.

The grip body is attached to the cover body or the air control body via the elastic member. Therefore, when the worker holds the grip body to perform the work, longitudinal vibration and the like generated by the cylinder portion are absorbed by the elastic member, and vibration being transmitted to the worker is largely reduced. For example, the worker grasps the grip body attached to the cover body with one hand and the grip body attached to the air control body with the other hand to perform the work, and a load due to vibration is thereby remarkably reduced.

### Effect of the Invention

The air hammer tool of the present invention has effects such that vibration and noise transmitted to the worker are reduced remarkably, and it can be manufactured at a low cost and easily maintained because it has a simple and light-weight structure. Further, the method of adjusting the impact force of the air hammer tool of the present invention has an effect such that the impact force can be easily and finely adjusted.

### BRIEF DESCRIPTION OF DRAWINGS

FIG. 1 is a vertical cross-sectional view of an air hammer tool;

FIG. 2 is a vertical cross-sectional view showing another state of the air hammer tool;

FIG. 3 is an A-A cross-sectional view of FIG. 1;

FIG. 4 is a partial vertical cross-sectional view showing the interior of a cylinder portion in a magnified fashion;

FIGS. 5 are a table and graphs related to vibration absorption performance, showing a comparison between the air hammer tool according to the present invention and a conventional product, in which FIG. 5A shows average values, FIG. 5B shows a performance change of the product of the present invention over time, and FIG. 5C shows a performance change of the conventional product with over time;

FIG. 6 is a conceptual diagram showing a measurement method;

FIG. 7 is a vertical cross-sectional view of an air hammer tool according to another embodiment; and

FIG. 8 is a vertical cross-sectional view of the air hammer tool according to the other embodiment.

### MODE FOR CARRYING OUT THE INVENTION

Embodiments of the air hammer tool of the present invention will be described below with reference to the accompanying drawings

For convenience of description, it is considered that a tip direction of the air hammer tool is front and a base end direction is rear. However, it should not be construed as excluding the air hammer tool which. is used in an upward or downward direction. Further, the air hammer tool of the present invention is not limited to the following embodiments, but any design change can be appropriately made without departing from the scope of the present invention.

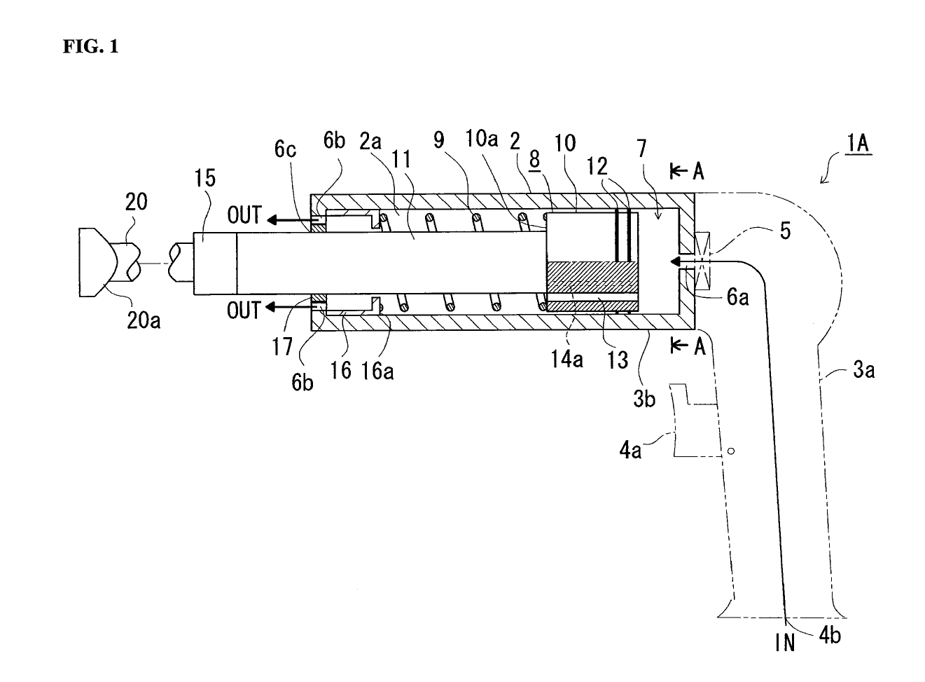

As shown in FIG. 1, an air hammer tool 1A is a tool using pressured air as and includes a cover body 2 in which the pressured air s injected from the outside, and a tip tool 20 which extends forward from the cover body 2.

The cover body 2 is made of a metal material and has a grip portion 3a which is grasped by a worker during work and a main body Portion 3b having a substantially cylindrical shape which is continuously formed on the top of the grip portion 3a to extend along the longitudinal direction.

A trigger portion 4a is positioned at a front face portion of the grip portion 3a. Operation of the trigger portion 4a enables control of the supply of the pressured air to the air hammer tool 1A. Further, an air supply port 4b for introducing the pressured. air from the outside is formed at the lower end of the grip portion 3a.

To a pressured air introducing mechanism, which introduces the pressured air into the cover body 2 from the outside and enables flexible control inflow of the pressured air by the trigger portion 4a, a well-known mechanism is suitably adopted.

The main body portion 3b has an inner space portion 2a formed along the longitudinal direction. Further, a gas pressure-injection portion 6a for inject of the pressured air into the inner space portion 2a is formed in a peripheral wall at the rear end of the main body portion 3b. Further, a valve 5 is internally disposed adjacent to the gas pressure-injection portion 6a. The pressured air introduced from the grip portion 3a flows into the inner space portion 2a of the main body portion 3b through the valve 5. Further, a gas discharge portion 6b is formed in a peripheral wall at the front end of the main body portion 3b, enabling the pressured air introduced into the main body portion 3b so be discharged therethrough.

Further, a sliding body 8 is fitted to be longitudinally slidable in the inner space portion 2a of the main body portion 3b The sliding body 8 is made of a metal material and has a sliding body main body portion 10 having a large-diameter cylindrical shape, and a cylinder portion 11 having a cylindrical shape which extends forward from the center of a front end face 10a of the sliding body main body portion 10 as shown in FIG. 1. In addition, the cylinder portion 11 protrudes from the cover body 2 through a cylinder portion extension opening 6c which opens at the front end of the main body portion 3b. A bearing member 17 internally contacts with the inner edge of the cylinder portion extension opening 6c, and the cylinder portion 11 is slidably supported by the bearing member 17.

Further, the outer peripheral surface of the sliding body main body portion 10 is fitted with plural O-rings 12. Further, the O-rings 12 are tightly attached to the inner peripheral surface of the main body portion 3b. Further, in the inner space portion 2a of the main body portion 3b, a highly airtight pressured air inflow chamber 7 is formed between the rear end face of the sliding body 8 and the inner peripheral surface of the main body portion 3b which is opposed to the rear end face.

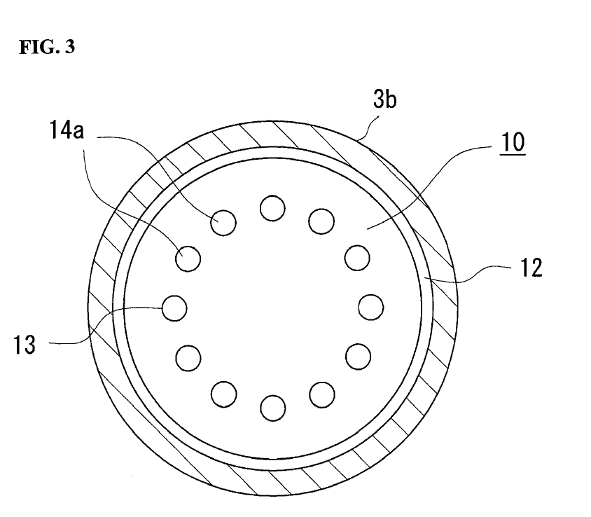

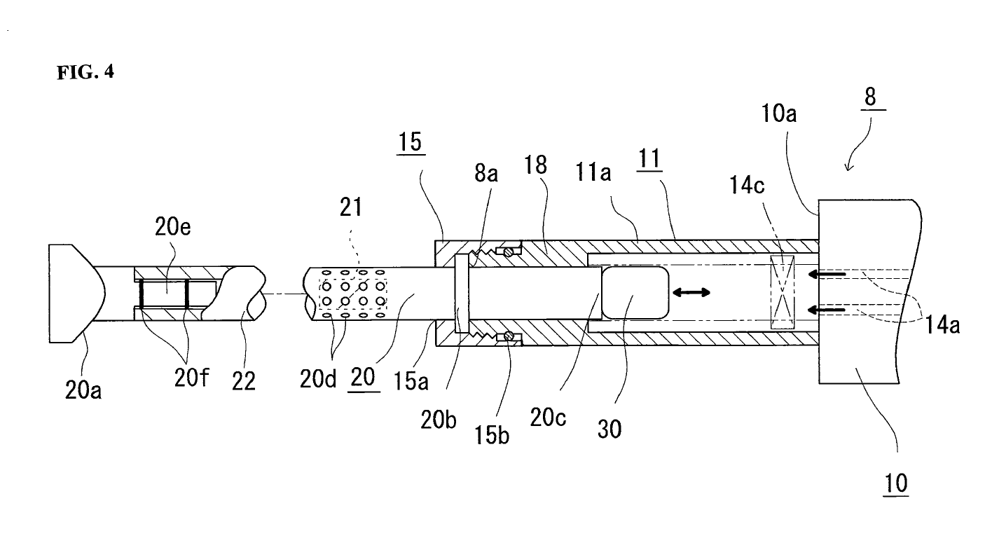

Further, as shown in FIGS. 3 and 4, plural gas passages are formed through the sliding body main body portion 10. Further, among the plural gas passages, a gas discharge relay portion 13 is configured with the gas passage which communicates between the pressured air inflow chamber 7 and the gas discharge portion 6b of the main body portion 3b, and a gas introduction. portion 14a is composed of a gas passage which. communicates the pressured air inflow chamber 7 and the inside of the cylinder portion 11.

In addition, as shown in FIG. 4, the cylinder portion 11 of the sliding body 8 has an outer cylinder portion 11a. Further, a supply-exhaust. switching valve 14c is positioned at a base end portion in the outer cylinder portion 11a. On the other hand, a fitting portion 18, which is formed by internally thickening a peripheral wall around a front-end opening portion 8a, is formed at the front-end opening portion 8a of the outer cylinder portion 11a, and the tip tool 20 is fixed to the fitting portion 18 in a manner incapable of relative movement with respect to the cylinder portion 11.

As shown in FIG. 1, the tip tool 20 is made of a metal material, has a tip tool main body 22, and also has a pile-shaped chisel portion 20a which is attached to a tip end of the tip tool main body 22, a disc-shaped retaining portion 20b which is formed at an intermediate portion of the tip tool main body 22, and a rear end portion 20c which protrudes rearward from the center or the retaining portion 20b. Further, the rear end portion 20c of the tip tool 20 is inserted into the fitting portion 18 through the front-end opening portion 8a of the outer cylinder portion ha and extends into the cylinder portion 11, and a surface of the retaining portion 20b contacts with the tip end face of the outer cylinder portion 11a. In addition, this contact portion is covered with a cap-shape chuck body 15 which has a tip tool insertion hole 15a, through which the tip tool 20 is inserted, formed at the center. With the chuck body 15 put on, the retaining portion 20b is held between the inner face of the chuck body 15 and the tip end face of the outer cylinder portion 11a, and the chuck body 15 and the tip end portion of the cylinder portion 11 are screwed in each other via an O-ring 15b, which is attached to the outer periphery of the fitting portion 18. Thus, the tip tool 20 is firmly fixed so that it does not drop off from the cylinder portion 11. Incidentally, the chuck body 15 is detachable from the cylinder portion 11; therefore, the tip tool 20 is replaceable.

Next, the structure of the above tip tool 20 is described below in further detail.

As shown in FIG. 4, a shaft portion 20e is continuously formed at a base end portion of the chisel portion 20a, and O-rings 20f are fitted. on the shaft portion 20e. Further, the shaft portion 20e is fitted into and fixed. to the front end. of the tip tool main body 22. The shaft portion 20e is detachable from the tip tool main body 22, and the chisel portion 20a can thereby be appropriately replaced.

Further, as shown in FIG. 4, a portion in front of the retaining portion 20b of the tip tool main body 22 is formed to have a cylindrical shape. Further, a buffer material 21 made of a fibrous material such as felt (a needle punched non-woven fabric) consisting of polyester fiber is filled in the tip tool main body 22 to reduce noise by the fibrous material. In addition, plural heat radiation holes 20d for preventing the buffer material 21 from having an excessive temperature rise due to obtained heat energy are formed in the peripheral wall, of the tip tool main body 22 at the portion where the buffer material 21 is filled.

Next, the cylinder portion 11 will be described in detail.

A hammer 30 made of a metal material is slidably fitted in the outer cylinder portion ha of the cylinder portion 11. The hammer 30 has appropriately set optimum size and weight.

In addition, as shown in FIG. 1 and others, a single coil spring 9 (elastic body) is externally fitted on the outer periphery of the cylinder portion 11. In further detail, the cover body 2 has an annular spring stop portion 16 which is provided at the front end portion of the main body portion 3b, and the coil spring 9 is interposed in a longitudinally oriented state between a rear end face 16a of the annular spring stop portion 16 and the front end face 10a of the sliding body main body portion 10 and functions as a compression spring.

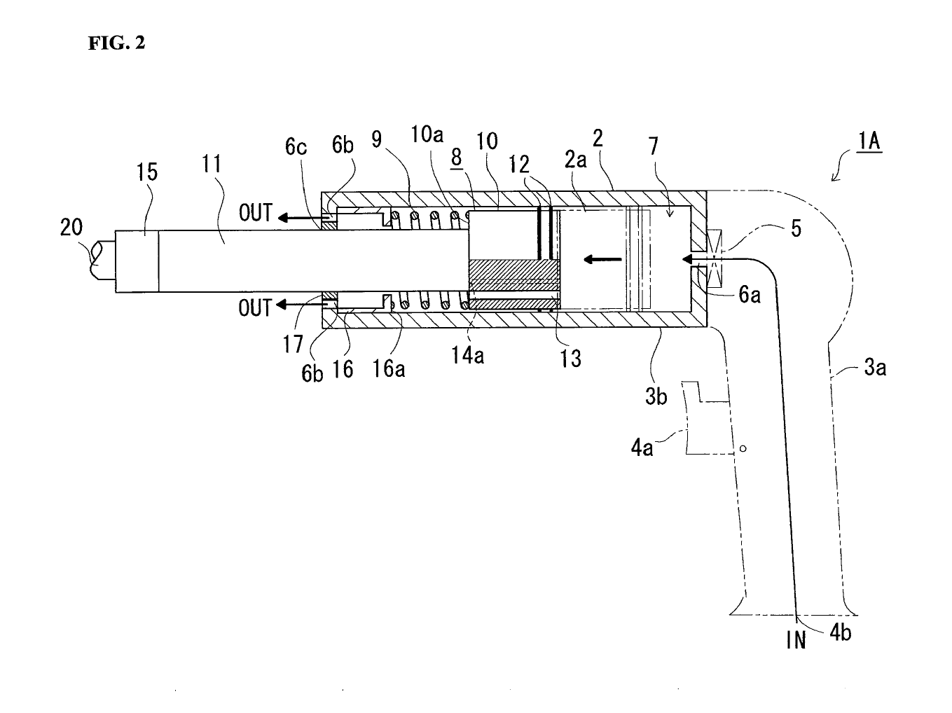

When the above air hammer tool 1A is used, the tip end of the tip tool 20 is pushed against an object to be impacted (not shown) such as a rock or a concrete block, and the trigger 4a is operated. Then, the pressured air is continuously injected into the pressured air inflow chamber 7 through the gas pressure-injection portion 6a of the main body portion 3b while the valve 5 prevents from reverse flow to the air supply port 4b. Further, the sliding body 8 obtains a state where it is pushed forward by the pressure increased in the pressured air inflow chamber 7. When the sliding body 8 is pushed forward, as shown in FIG. 2, the volume of the pressured air inflow chamber 7 is increased, and the coil spring 9 is elastically contracted between the spring stop portion 16 and the sliding body main body portion 10, the sliding body 8 is urged rearward.

Further, the pressured air which is injected into the main body portion 3b is discharged from the gas discharge portion 6b to the outside of the cover body 2 through she gas discharge relay portion 13 formed in the sliding body main body portion 10. At the same time, the pressured air which is injected into the main body portion 3b is introduced into the cylinder portion 11 through the as introduction portion 14a of the sliding body main body portion 10, its flowing direction is appropriately controlled by the supply-exhaust switching valve 14c to make the hammer 30 perform. a reciprocating motion in the longitudinal direction. Further, the hammer 30 performing the reciprocating motion repeatedly impacts against the rear end portion 20c of the tip tool 20. Thus, an impact force is applied continuously to the object to be impacted through the tip tool 20. To the mechanism in which the hammer 30 performs a reciprocating motion in the cylinder portion 11, a well-known mechanism can be adopted suitably. For example, the well-known mechanism disclosed in JP-A-Hei 9-11156 can be applied to the present air hammer tool 1A.

In the above structure, the cover body 2 which is held by a hand of the worker and the sliding body 8 in which the hammer 30 for impacting the tip tool 20 is inserted are provided as separate bodies, and the coil spring 9 is interposed between the cover body 2 and the sliding body 8; therefore, the shock generated when the hammer 30 and the tip tool 20 impact with each other and the inertia of the hammer 30 performing the reciprocating motion are properly absorbed by the coil spring 9. Therefore, the transmission of vibration to the worker using the air hammer tool 1A is hindered effectively.

Further, the tip tool 20 is integral with the sliding body 8, and the impact force generated at the time of impact of the hammer 30 is merely transmitted to the object to be impacted. Therefore, large vibration is not transmitted to the grip portion 3a of the cover body 2. Therefore, the air hammer tool 1A generates exceedingly small vibration in comparison with that of the air hammer tool in which the tip tool having a conventional structure vibrates. As a result, by using the air hammer tool having the conventional structure, a serious problem such as vibration white finger disease or a hearing disorder to which the workers are subject can be hindered from occurring.

In addition, the above air hammer tool 1A has a simple inside structure, a small number of parts, a compact entire structure, and a light weight. Therefore, its manufacturing cost is lowered. Further, since it can easily be disassembled, it has an advantage of facilitating its maintenance work.

Further, the air hammer tool 1A has the tip tool 20 which moves to a forward protruded position during the work (see FIG. 1), but when the trigger 4a is operated to pause the operation, it is released from the pressure of the pressured air, the sliding body 8 is returned

to the original, position by the urging force of the coil spring 9, and the tip tool 20 moves to a retreated position (see FIG. 2). That is, in the air hammer tool 1A, when the work is paused to stop the injection of the pressured air, the tip tool 20 itself retracts backward to separate from the object to be impacted. Therefore, for example, when plural workpieces (objects being impacted) are processed sequentially, it is not necessary to separate the air hammer tool 1A itself from the work every time the operation is paused. This enables replacement of the workpieces sequentially in response to, for example, timings when the tip tool 20 is retreated.

For reference, noise measured by a prototype corresponding to the above-described structure was about 90 dB, and noise measured by a general-purpose conventional product not provided with the above-described coil spring 9 was about 95 dB (Sound level meter used: Model SL-310 manufactured by Multi Measuring Instruments Sales Co., Ltd.).

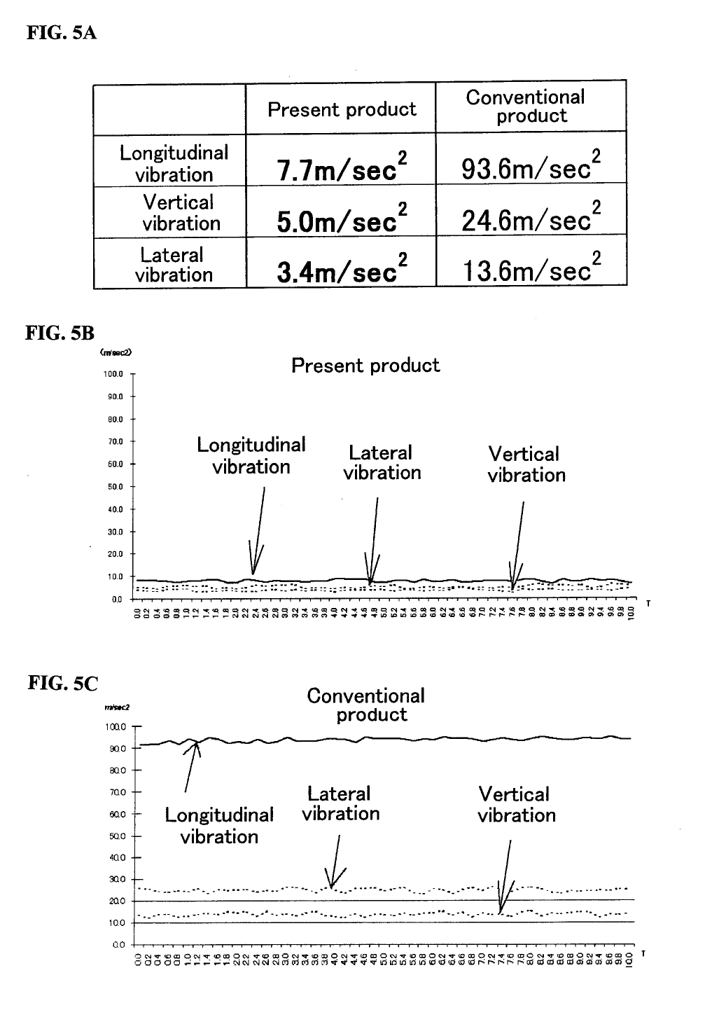

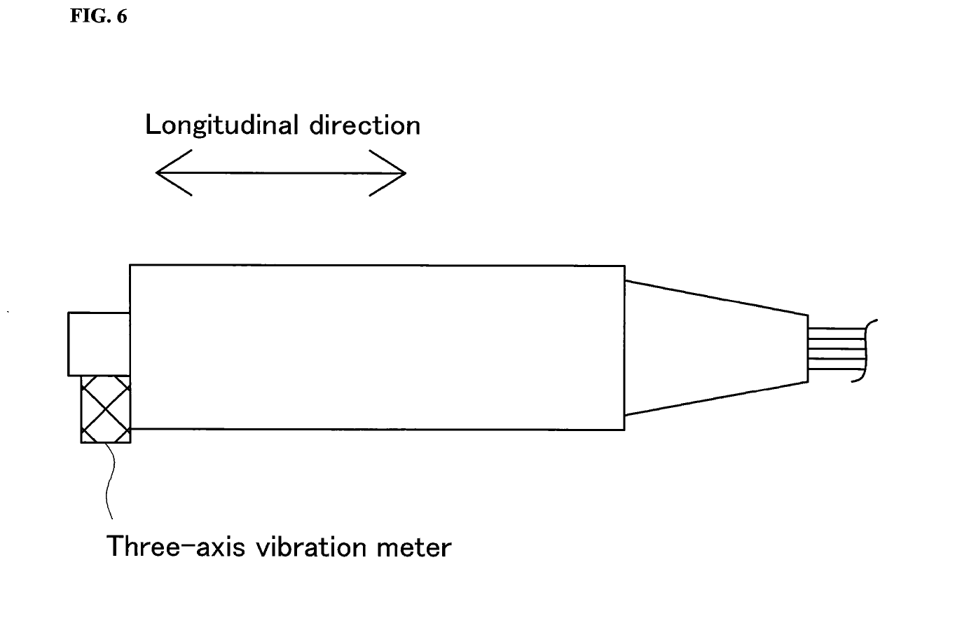

Further, the air hammer tool according to the present invention and the conventional product (not provided with the coil spring 9) are compared for the vibration absorption performance with reference to FIGS. 5. For measurement of vibration, as shown in FIG. 6, vibrations in three axes (longitudinal, vertical and lateral) at the rear end portion of the tool main body were measured by a commercially available 3-axis vibration meter. The pressure of the pressured air used for measurement was 0.25 MPa. measuring time was 10 seconds (T). The tip tool 20 had a brush type shape. A vibration meter manufactured by Rion Co., Ltd. (Model: UV0) was used. Measuring equipment manufactured by Yokogawa Meters & Instruments Corporation (Model: DL750) was used. A piezoelectric acceleration pick-up manufactured by Rion Co., Ltd. (Model: PV-97C) was used. A vibration calibrator manufactured by Rion Co., Ltd. (Model: VE-10) was used.

As shown in FIG. 5A, is was found from the measured results that the product of the present invention is excellent in vibration absorption performance in three axes in comparison with the conventional product. Especially, about the longitudinal vibration, about 92% attenuation was obtained. Further, the measured values obtained by the above 3-axis vibration meter were stable values with little dispersion within the measurement time as shown in FIGS. 5B and 5C. As described above, it is also clear from an objective measurement in which the air hammer tool according to the present invention has the improved vibration absorption performance.

### Second Embodiment

An air hammer tool 1B according to a second embodiment will be described below, but descriptions on points in common with those in the first embodiment will be simplified or omitted, and the same reference numerals and symbols will be used on the drawing.

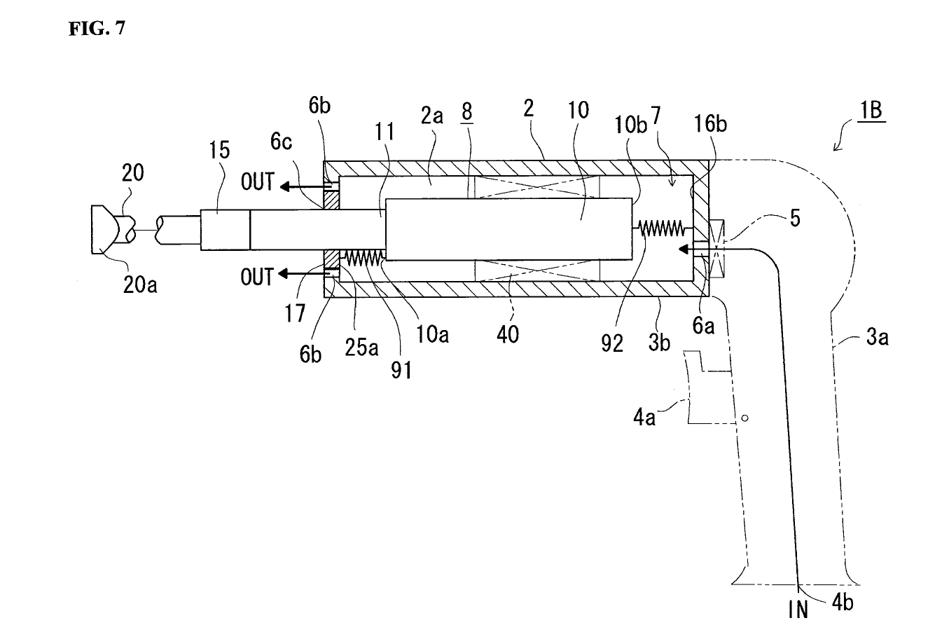

As shown in FIG. 7, the air hammer to 1B is provided with a first coil spring 91 and a second coil spring 92. The first coil spring 91 is interposed in a longitudinally oriented state between the front end face 10a of the sliding body main body portion 10 of the sliding body 8 and an inner peripheral end face 25a in front of the cover body 2. On the other hand, the second coil spring 92 is interposed in a longitudinally oriented state between the rear end face 10b of The sliding body main body portion 10 of the sliding body 8 and an end face 16b formed on the inner peripheral surface of the main body portion 3b positioned in the rear of the rear end face 20b. Further, in the above fitted state, the second coil spring 92 is in an elastically contracted state and urges the sliding body 8 forward.

In addition, a support body 40 which is made of a well-known bearing member is positioned within the cover body 2, and the support body 40 is in contact with the side face portion of the sliding body 8 to longitudinally moveably support the sliding body 8, thereby preventing backlash of the sliding body 8.

In the above structure, in use of the air hammer tool 1B, the trigger 4a is operated to continuously inject the pressured air into the pressured air inflow chamber 7. Then, the sliding body 8 obtains a forward pushed state while being supported by the support body 40 by the pressure increased within the pressured air inflow chamber 7. When the sliding body 8 is in the forwardly pushed state, the first coil spring 91 obtains the elastically contracted state and urges the sliding body 8 rearward, and the second coil spring 92 in the elastically contracted state urges the sliding body 8 forward. Further, in the above state, the hammer 30 in the cylinder portion 11 performs a reciprocating motion. to repeatedly impact against the tip tool 20, and the impact force is applied continuously to the object to be impacted through the tip tool 20.

In the above structure, a vibration absorption effect and a noise reduction effect can be obtained by the first coil spring 91 on the front side. Further, the pressure of the pressured air is complemented by the second coil spring 92 on the back side to push appropriately the sliding body 8 forward, and the effect of stabilizing the impact force can thereby be obtained.

For reference, the impact force measured by a prototype corresponding to the above second embodiment was improved by about 20-30% in comparison with the impact force of the prototype corresponding to the first embodiment not provided with the second coil spring 92. The impact force was measured by a measuring instrument which digitizes the kinetic energy transmitted from the tip tool 20 on the basis of the acceleration.

Here, since the second coil spring 92 is set to have an appropriate spring constant, the impact force applied to the object to be impacted can be adjusted while sustaining the optimum vibration absorption effect and noise reduction effect.

For example, when it is desired to increase the impact force, a spring constant of the second coil spring 92 is changed to increase the urging force applied forward to the sliding body 8. Then, the sliding body 8 is pushed forward appropriately, the tip tool 20 is appropriately pushed against the object to be impacted accordingly, the sliding body 8 in the inner space portion 2a is prevented from jumping, and the impact force is increased. On the other hand, when it is desired to decrease the impact force, the spring constant of the second coil spring 92 is changed to reduce the urging force applied forward to the sliding body 8. Then, the impact force decreases because the above-described reverse principle functions in the reversed manner.

### Third Embodiment

In addition to the above structure, an air hammer tool 1C of another embodiment is suggested. Here, descriptions on points in common with those in the first and second embodiments will be simplified or omitted, and the same reference numerals and symbols are used on the drawing.

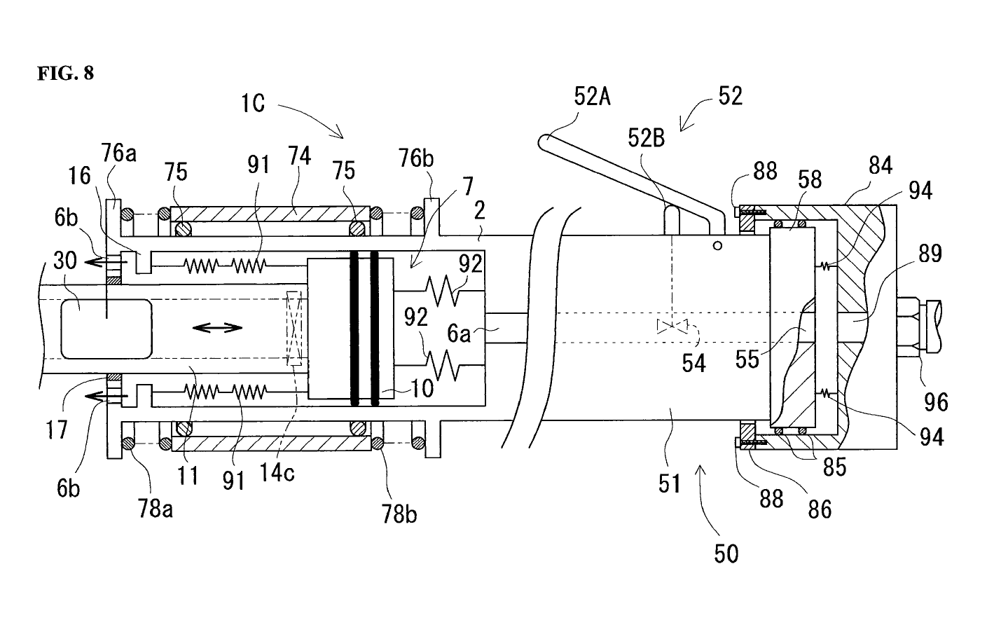

As shown in FIG. 8, an air control body 50 is disposed in the rear of the cover body 2. The air control body 50 is provided. with an air control body main body 51. A gas passage 55 is formed longitudinally through the interior of the air control body main body 51.

Further, an air control switch portion 52 is provided on the outer surface of the air control body main body 51. The air control switch portion 52 is provided with an operation portion 52A and an actuation portion 52B. The operation portion 52A is made of a long and narrow plate member, and its base end portion is pivotally supported by the side wall of the air control body main body 51. Further, the actuation portion 52B is made of a rod material which protrudes outward from the interior of the air control body main body 51, and its tip end is in contact with the rear face of the operation portion 52A. Further, when the operation portion 52A is operated, the actuation portion 52B moves vertically along its axial direction. In addition, an on-off valve 54, which is built in the air control body main body 51, is connected to the actuation portion 52B. Further, when the operation portion 52A is operated, the on-off valve 54 operates in association. with the actuation portion 52B, and the gas passage 55 is opened or closed as appropriate. For the mechanism of the on-off valve 54, a well-known technology can be applied suitably. For example, a well-known mechanism disclosed in JP-Y-3153805 can be applied to the air hammer tool 1C.

Further, the gas pressure-injection portion 6a of the cover body 2 and the gas passage 55 in the air control body 50 are airtightly formed to communicate with each other between the air control body 50 and the cover body 2.

Further, a front grip body 74 having a cylindrical, shape is externally fitted on the outer periphery of the above-described cover body 2 via O-rings 75 and 75 as elastic members. In this state, O-rings 75 and 75 are tightly attached to cover body 2 and front grip body 74 in a state held between them.

In addition, the coil springs 78a and 78b as the elastic members are interposed in the front and in the rear of the front grip body 74. Specifically, a spring stop portion 76a having a flange shape is disposed around the front end portion of the cover body 2, and the coil spring 78a is disposed. to cover the cover body 2 between the spring stop portion 76a and the front end face of the front grip body 74. On the other hand, a spring stop portion 76b having a flange shape is disposed around the rear end portion of the cover body 2, and the coil spring 78b is disposed between the spring stop portion 76b and the rear end face of the front grip body 74 to cover the cover body 2. The O-rings 75 have a vibration absorption function for hindering the vertical and lateral vibration generated in the cover body 2 from being transmitted to the front grip body 74. Further, the coil springs 78a and 78b have a vibration absorption function for hindering the longitudinal vibration generated in the cover body 2 from being transmitted to the front grip body 74.

In addition, a rear grip body 84 is attached to the rear portion of the above air control body 50. The rear grip body 84 is formed with a close-bottomed cylinder member. Further, the rear grip body 84 is externally fitted on the air control body 50 with the O-rings 85 and 85 as the elastic member interposed between them. Further, the coil springs 94 and 94 as the elastic members are interposed between the rear end face of the air control body 50 and the bottom portion, in other words, the rear end. portion of the rear grip body 84. The O-rings 85 have a vibration absorption function for hindering vertical and lateral vibrations transmitted to the air control body 50 from being transmitted to the rear grip body 84. Further, the coil springs 94 have a vibration absorption function for hindering the longitudinal vibration which is transmitted to the air control body 50 from being transmitted to the rear grip body 84.

A flared portion 58 with a large diameter is disposed at the rear end portion of the air control body main body 51. In addition, a ring-shaped stopper portion 86 is fixed to the front end of the rear grip body 84 with bolts 88. In the above structure, even if the rear grip body 84 is apt to drop rearwardly from the air control body main body 51, the engagement of the stopper portion 86 and the flared portion 58 prevents the grip body from dropping.

In addition, a pressured air introduction portion 96 is positioned at the rear end face of the rear trip body 84. The pressured air introduced from the outside through the pressured air introduction portion 96 passes through an air passage 89 in the rear grip body 84 and is then guided to the gas passage 55 in the air control body 50.

In the above structure, when the air control switch portion 52 of the air control body 50 is operated, the pressured air is first supplied to the gas passage 55 of the air control body 50 through the compressed air introduction portion 96 from the outside and then guided into the cover body 2 through she gas pressure-injection portion 6a of the over body 2. Thus, the hammer 30 is reciprocated longitudinally.

Here, the front grip body 74 is disposed around the cover body 2, the rear grip body 84 is disposed near the air control switch portion 52, and the worker can thereby grasp the front grip body 74 with one hand and the rear grip body 84 with the other hand to perform the work. By having the above structure, she vibration is hindered from being transmitted so the hand operating the air control switch portion 52 and the hand supporting the whole air hammer tool 1C; therefore, the extremely high vibration absorption performance is obtained.

In addition, according to the present invention, the cover body 2 and the tip tool 20 may be made of another material. For example, the grip portion 3a of the first embodiment may be made of an elastic material such as rubber so that it is grasped easily. Further, the material for the hammer 30 can appropriately be selected from well-known materials and may be configured with a core material and an outer shell covering the core material. Further, the hammer 30 may appropriately be provided with a surface treatment. Further, the hammer 30 may be configured by connecting plural block bodies, and the impact force and weight composition of the hammer 30 may be adjusted based on the number of the block bodies. Further, the elastic body made of a fibrous material may be filled into a desired portion. As the fibrous material, felt (a needle punched non-woven fabric) consisting of a polyester fiber can be adopted. Further, the fibrous material may be impregnated with oil to improve durability of the fibrous material. Further, the tip tool 20 may be, for example: a chisel for a rock drill, a concrete breaker or a chipping machine; a nail, a rivet or a pile for a nailer, a riveting machine or a pile driver; a ground leveling plate for a land leveler, a compactor, a rammer, a tamper, a road roller or a ground leveling machine; or a needle bunch for a jet chisel. Further, the gas to be pressured and injected into the air hammer tools 1A to 1C is not limited to the pressured air but maybe a gas such as an inert gas.

### DESCRIPTION OF REFERENCE NUMERALS AND SYMBOLS

1A to 1C: air hammer tool
2: cover body
2a: inner space portion
8: sliding body
8a: front-end opening portion
9, 91, 92: coil spring (elastic body)
20: tip tool
20c: rear end portion of tip tool
30: hammer
50: air control body
52: air control switch portion
74: front grip body (grip body)
84: rear grip body (grip body)
75, 85: O-ring (elastic member)
78a, 78b, 94: coil spring (elastic member)

1. An air hammer tool, comprising:
a cover body and a tip tool which is extended forward from the cover body; and
an impact force obtained by a gas, which is pressured and injected into said cover body, being applied to an object to be impacted through said tip tool,
wherein said cover body has an inner space portion which is formed along the longitudinal direction, a gas pressure-injection portion which is formed in the peripheral wall of the cover body to a gas pressured and injected, forward into the inner space portion, the inner space portion has therein a longitudinally slidable sliding body and an elastic body which is interposed between the outer peripheral surface of the sliding body and the inner peripheral surface of the cover body,
said sliding body has a. sliding body main body and a cylinder portion which has a cylindrical shape and is disposed at a front end portion of the sliding body main body to protrude forward from said cover body,
a gas introduction portion for guiding the gas pressured and injected, into said cover body into the cylinder portion and a gas introduction portion is formed in a peripheral wall of the cylinder portion, a hammer is longitudinally slidably loaded in the cylinder portion, a rear end portion of said tip tool is fixed to a front-end opening portion of the cylinder portion to be impactable with said hammer,
when the gas is pressured and injected into said cover body through said gas pressure-injection portion, said sliding body is moved forward in the cover body by the pressure of the gas while elastically deforming the elastic body, and the hammer is longitudinally reciprocated within the cylinder portion by the gas introduced into said cylinder portion through said gas introduction portion ,and said hammer repeatedly impact against the rear end portion of said tip tool, thereby providing said impact force.

2. The air hammer tool according to claim 1,
wherein said elastic body is a coil spring,
the coil spring is interposed in a longitudinally oriented state between a front end face of said sliding body and an inner peripheral surface of said cover body,
when the gas is pressured and injected into said cover body through said gas pressure-injection portion to move forward said sliding body, the coil spring is elastically contracted to urge the sliding body rearward.

3. The air hammer tool according to claim 2,
wherein a coil spring as the elastic body is also interposed in a longitudinally oriented and elastically contracted state between the rear end face of said sliding body and the inner peripheral surface of said cover body, and
the coil spring urges the sliding body forward with said sliding body in a forward moved state by the gas pressured and injected, into said cover body through said gas pressure-injection portion.

4. The air hammer tool according to claim 1,
wherein an air control body to which a gas is supplied from an outside is disposed in rear of said cover body, and an air control switch portion disposed on the air control body is operated to guide the gas supplied from the outside to said gas pressure-injection portion formed in said cover body, and
a cylindrical grip body is externally fitted to the outer periphery of said cover body and/or the outer periphery of said air control body along the longitudinal direction via an elastic member.

5. A method of adjusting an impact force of the air hammer tool according to claim 3,
wherein the coil spring interposed between the front end face of said sliding body and the inner peripheral surface of said cover body is provided as a first coil spring,
the coil spring interposed between the rear end face of said sliding body and the inner peripheral surface of said cover body is provided as a second coil spring, and
an urging force of the second coil spring against said sliding body is changed to adjust said impact force.
